(19) United States
(12) Patent Application Publication
(10) Pub. No.: US 2017/0366019 A1
(43) Pub. Date: Dec. 21, 2017

(54) Battery Switching System and Method Thereof

(71) Applicant: EcoReco Global Corporation, Victoria (SC)

(72) Inventors: Chieh Sung, Victoria (SC); Francis Jungwon LEE, San Jose, CA (US)

(21) Appl. No.: 15/184,857

(22) Filed: Jun. 16, 2016

(51) Int. Cl. H02J 7/00

(52) U.S. Cl. CPC H02J 7/0019; H02J 7/0016; H02J 7/0026

(57) ABSTRACT

A battery switching system is provided for battery operation. The battery switching system includes at least one first battery device and one second battery device, and a battery switch device. The first battery device and the second battery device have different voltages. The battery switch device has an accommodating space to accommodate the first battery device and the second battery device. When the battery switch device is in a charge mode, the battery switch device charges the first battery device and second battery device of lower voltage to match the voltage of the other of the first battery device and second battery device of higher voltage before simultaneously charging both the first battery device and second battery device. When the battery switch device is in a power mode, the battery switch device drains the first battery device and second battery device of high voltage to match the voltage of the other of the first battery device and second battery device of lower voltage before simultaneously draining both the first battery device and second battery device.

### BACKGROUND

### 1. Technical Field

The present disclosure generally relates to a battery switching system and method thereof for operating different battery devices; particularly, the present disclosure relates to a battery switching system and method thereof for operating power charging and draining of batteries with differing voltages.

### 2. Description of the Related Art

As the world's power usage increases, technologies pertaining to power storage are also rapidly advancing as well. As technologies are becoming more miniaturized and portable, it has become natural to custom design power storages to fit the design of the portable technologies. For instance, traditional personal electric vehicles such as electric scooters are typically designed to have one battery unit, wherein the wattage and physical size and shape of the battery unit is custom to the electric scooter. However, there are problems that are associated with this type of design. One problem is that consumers are not satisfied with having to wait for the long period of time required to fully charge the single battery unit. Another problem is that continually stringent government regulations have often meant that battery sizes typically found in personal electric vehicles are not allowed onto airplanes, which then means that the personal electric vehicle is not truly portable anymore. Subsequently, there is a need to modularize the power storage into smaller units so that the above problems may be overcome to provide a more portable and convenient solution.

### SUMMARY

It is an objective of the present disclosure to provide a battery switching system and method thereof for operating batteries of different wattages.

It is another objective of the present disclosure to provide a battery switching system and method thereof to decrease size of batteries through modularization.

According to one aspect of the invention, a battery switching system is provided. The battery switching system includes at least one first battery device and one second battery device, and a battery switch device. The first battery device and the second battery device have different voltages. The battery switch device has an accommodating space to accommodate the first battery device and the second battery device. When the battery switch device is in a charge mode, the battery switch device charges the first battery device and second battery device of lower voltage to match the voltage of the other of the first battery device and second battery device of higher voltage before simultaneously charging both the first battery device and second battery device. When the battery switch device is in a power mode, the battery switch device drains the first battery device and second battery device of high voltage to match the voltage of the other of the first battery device and second battery device of lower voltage before simultaneously draining both the first battery device and second battery device.

According to another aspect of the invention, a method for battery operation is provided. The method includes: a) determining if battery switch device is connected to a charger device or a power draining device and generating a mode determination result; b) according to the mode determination result, entering into a charge mode or a power mode; c) charging one of the first battery device and the second battery device of lower voltage until both the first battery device and the second battery device have same voltage if in the charge mode, and then simultaneously charging both the first battery device and the second battery device; d) draining one of the first battery device and the second battery device of higher voltage until both the first battery device and the second battery device have same voltage if in the power mode, and then simultaneously draining both the first battery device and the second battery device.

### BRIEF DESCRIPTION OF THE DRAWINGS

FIG. 1 is a view of an embodiment of the battery switching system of the present invention;

FIG. 2A is an embodiment of the battery switching system coupled to a charger device;

FIG. 2B is an embodiment of the battery switching system coupled to a power draining device;

FIG. 2C is an embodiment of the battery switching system coupled to both the charger device and the power draining device;

FIG. 3 is an embodiment of a schematic diagram of the battery switching system; and

FIG. 4 is an embodiment of the flowchart of the battery operation method of the present invention.

### DETAILED DESCRIPTION OF THE PREFERRED EMBODIMENT

Embodiments of the present invention provide methods and systems for signaling battery switching system. In the following detailed description, references are made to the accompanying drawings that form a part hereof, and in which are shown by way of illustration specific embodiments or examples. These embodiments are only illustrative of the scope of the present invention, and should not be construed as a restriction on the present invention. Referring now the drawings, in which like numerals represent like elements through the several figures, aspects of the present invention and the exemplary operating environment will be described.

The present disclosure provides a battery switching system and method thereof. Preferably, the battery switching system and method may be applicable to any device or vehicle that would require power storage. Devices may include computers, laptops, mobile telephones, and any other related portable devices. Vehicles may include (but not limited to) personal electric vehicles such as electric scooters, power boasted skateboards, and other related personal transportation vehicles.

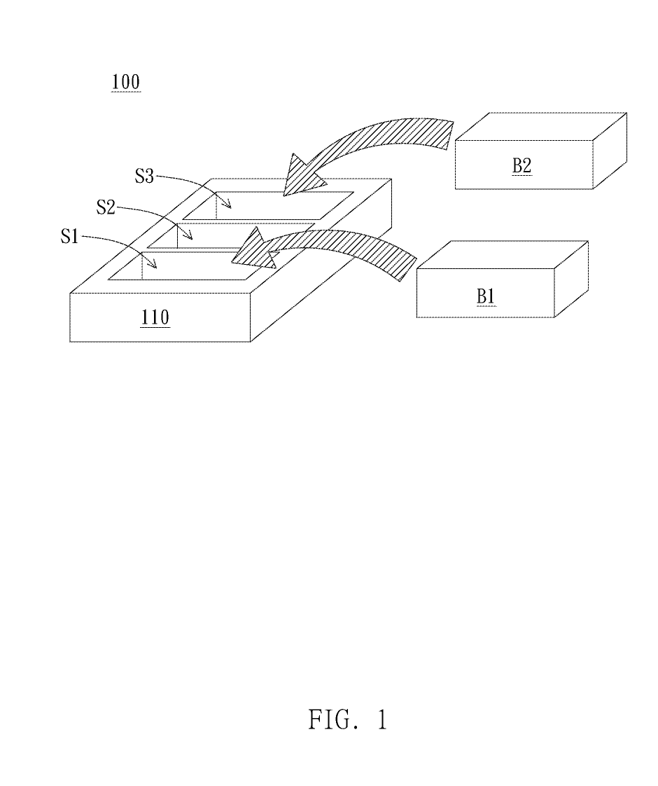

FIG. 1 is an embodiment of the battery switching system 100 of the present invention. The battery switching system includes at least one first battery device B1, a second battery device B2, and a battery switch device 110.

As illustrated in FIG. 1, the battery switch device 110 has at least one accommodating space to accommodate the first battery device B1 and/or second battery device B2. For instance, in FIG. 1, the accommodating space includes slot S1, slot S2, and slot S3. However, it should be noted that the battery switching system 100 of the present invention is not limited to having only one accommodating space, nor is the accommodating space limited or restricted to being realized through 3 slots. In addition, the accommodating space is also not limited to being divided into slots. In one embodiment, the accommodating space can be adjusted in size and/or shape to suit the size and/or shape of the first battery device B1 and/or second battery device B2.

In the present embodiment, the battery switch device 110 is used for operating one or multiple of battery devices. For instance, in the embodiment illustrated in FIG. 1, the battery switch device 110 operates, oversees, or regulates the first battery device B1 and the second battery device B2 when the first battery device B1 and the second battery device B2 are inserted into the accommodating space of the slot S1-S3 of the battery switch device 110. As part of operating the first battery device B1 and second battery device B2, the battery switch device 110 can decide whether to utilize the power stored in the first battery device B1 and/or the second battery device b2 in order to power another electrical device, or to charge the first battery device B1 and/or the second battery device B2. It should be noted that if the battery switch device 110 is to charge the first battery device B1 and/or the second battery device B2, these batteries would have to be rechargeable batteries. Examples of rechargeable batteries may include (but not limited to) batteries based upon Lithium Ion, Lithium iron phosphate, Aluminium-ion, and other related rechargeable batteries.

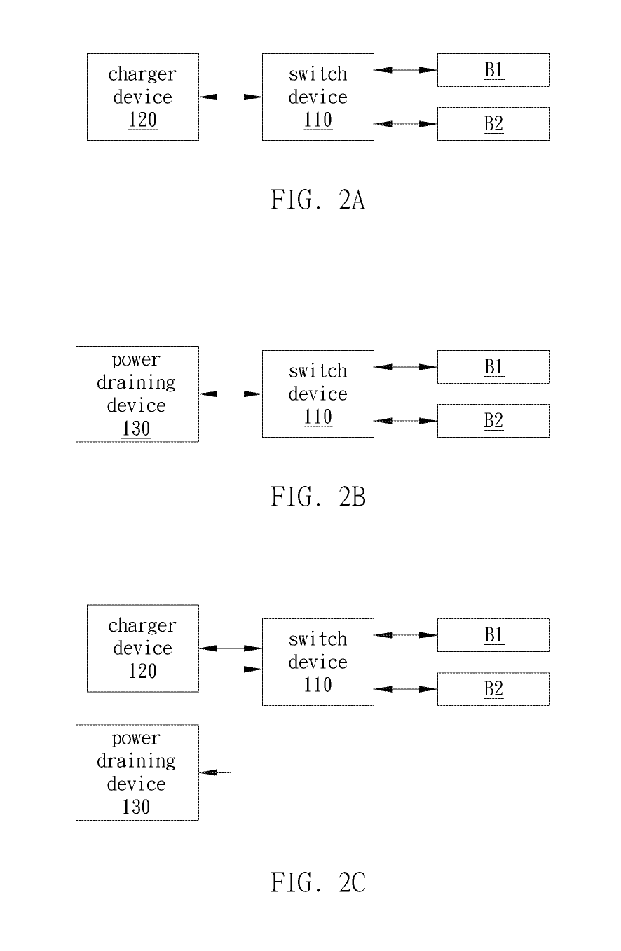

FIG. 2A is an embodiment of the battery switch device 110 being coupled to a charger device 120. In the present embodiment, the charger device 120 can be any device or source of power that the battery switch device 110 can draw on in order to charge the first battery device B1 and/or the second battery device B2. For instance, if the battery switching system 100 is applied toward an electric scooter, wherein the first battery device B1 and the second battery B2 are rechargeable batteries of the electric scooter, the charger device 120 can be the power source when the electric scooter is plugged into an electric wall socket or electric recharging station.

FIG. 2B is another embodiment of FIG. 2A, wherein a power draining device 130 instead is coupled to the battery switch device 110. In the present embodiment, the power draining device 130 is any device that uses the power stored in the first battery device B1 and/or second battery device B2 through the battery switch device 110. In the example given above with the electric scooter, the power draining device 130 would include the electric motor of the electric scooter and any other electronic gear on the electric scooter that would use electricity/power.

FIG. 2C is an embodiment of the battery switching system 100, wherein the battery switch device 110 is coupled to both the charger device 120 and the power draining device 130. In the present embodiment, with reference to the scooter example, an example of the battery switch device 110 being coupled to both the charger device 120 and the power draining device 130 could be a hybrid-electric personal vehicle. For instance, the charger device 120 could exemplarily be a gas engine that produces electric power from gasoline, while the power draining device 130 could exemplarily be the electric motor that is driving the motion of the scooter.

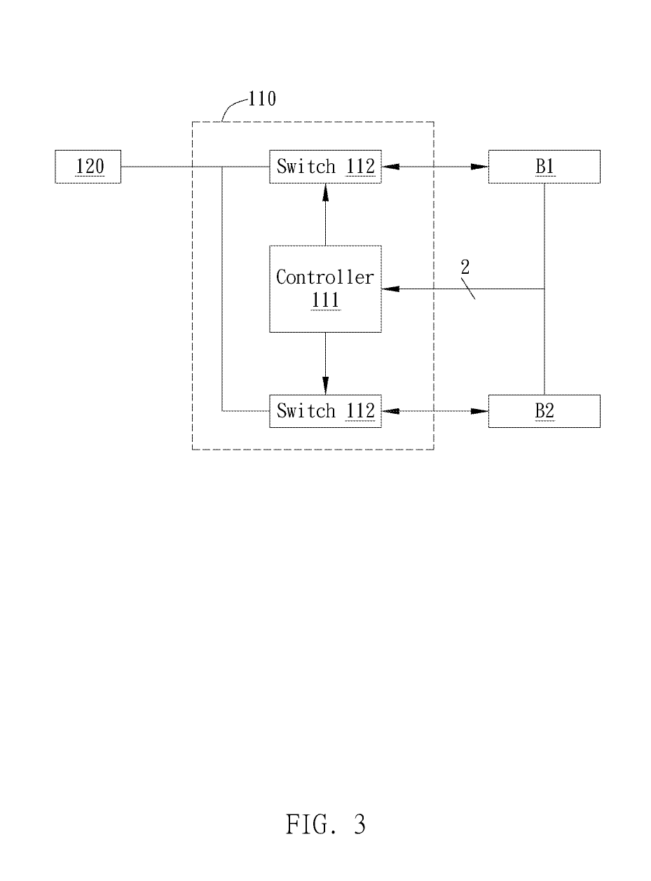

As illustrated in FIG. 3 of an embodiment of a schematic diagram of the battery switching system 100, the battery switch device 110 may further include a controller device 111 and one or a plurality of switches 112. In the present embodiment, each switch 112 corresponds to each battery device that is connected to the battery switch device 110. For instance, as shown in FIG. 3, the first battery device B1 and the second battery device B2 respectively connect to their own switches 112. In the present embodiment, these switches 112 are disposed in a parallel circuit to their respective corresponding battery devices. The controller device 111 is connected to each of the battery devices (ex. first battery device B1 and second battery device B2) through their corresponding switches 112.

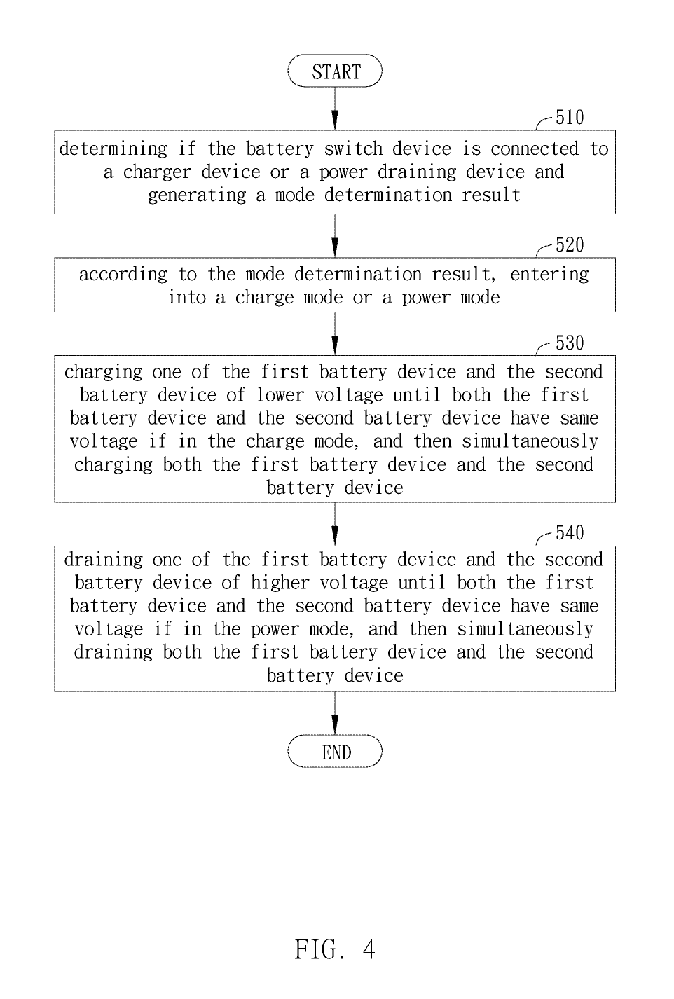

The following describe the steps in which the battery switching system 100 regulates the power levels of the battery devices (ex. first battery device B1 and second battery device B2). FIG. 4 of the battery operation method should be referenced in conjunction with FIGS. 2A-3:

When one or more battery devices are connected to the battery switch device 110 of the battery switching system 100, the controller device 111 of the battery switch device 110 will note which battery devices are currently connected to the battery switch device 110. In the present embodiment, for simplicity of describing the invention, only two battery devices (first battery device B1 and second battery device B2) will be mentioned. However, in other different embodiments, it can be understood that multiple battery devices may be connected at the same time to the battery switching system 100.

Step 510 includes determining if the battery switch device is connected to a charger device or a power draining device, and generating a mode determination result. In the present embodiment, the controller device 111 of the battery switch device 110 will first determine whether the charger device 120 (exemplarily shown in FIG. 2A) or the power draining device 130 (exemplarily shown in FIG. 2B) is connected to the battery switching system 100. According to this determination, the controller device 111 will generate a mode determination result that will decide whether the battery switching system 100 will enter the charge mode or the power mode.

Step 520 includes entering into the charge mode or the power mode according to the mode determination result. In the present embodiment, if the controller device 111 detects that the charger device 120 is connected to the battery switching system 100, the mode determination result will reflect this information and the controller device 111 will drive the battery switching system 100 to enter into the charge mode. Likewise, if the controller device 111 detects that the power draining device 130 is connected to the battery switching system 100, the mode determination result will reflect this information and the controller device 111 will drive the battery switching system 100 to enter into the power mode.

Step 530 includes charging the first battery device B1 and the second battery device B2 if the battery switching system 100 is in the charge mode. In the present embodiment, once the battery switching system 100 is in the charge mode, the controller device 111 will first determine which of the combination of the first battery device B1 and the second battery device B2 has comparatively lower voltage. Since the first battery device B1 and the second battery device B2 may or may not have different wattages, the voltage levels in the first battery device B1 and the second battery device B2 may be different. Under these circumstances, simultaneously charging both the first battery device B1 and the second battery device B2 would be inadvisable. Accordingly, in the present embodiment, after figuring out which of the first battery device B1 and the second battery device B2 has lower voltage levels, the controller device 111 will divert power from the charger device 120 to the battery device with lower voltage via the corresponding switch 112 until the voltage level of this battery device matches the voltage level of the other battery device. For instance, if the first battery device B1 was found to have lower voltage than the second battery device B2, the controller device 111 will divert power to the first battery device B1 to charge the first battery device B1 until its voltage level matches the voltage level of the second battery device B2. Once the voltage level of the first battery device B1 and the second battery device B2 matches, the controller device 111 will then divert power from the charger device 120 to simultaneously charge both the first battery device B1 and the second battery device B2. In this manner, different batteries of different wattages can still effectively be charged at the same time in the same battery charging system. This allows users to be able to swap or change different kinds of batteries into the system without having to worry about how the different batteries would operate with each other.

Step 540 includes draining one of the first battery device and the second battery device of higher voltage if the battery switching system 100 is in the power mode. In the present embodiment, if the battery switching system 100 is in the power mode, the controller device 111 will start to divert power from the combination of the first battery device B1 and the second battery device B2 to the power draining device 130. To accomplish this, the controller device 111 will first determine which of the first battery device B1 and the second battery device B2 has higher voltage levels. As mentioned above, since the first battery device B1 and the second battery device B2 may or may not have different wattages, it would be inadvisable to suddenly drain power from both of the first battery device B1 and the second battery device B2.

After the controller device 111 has figured out which of the first battery device B1 and the second battery device B2 has comparatively higher voltage levels, the controller device 111 will divert power from the one of the first battery device B1 and the second battery device B2 with higher voltage level to the power draining device 130 until both the voltage levels of the first battery device B1 and the second battery device B2 matches. Once the voltage levels match, the controller device 111 will then simultaneously drain or divert power from both the first battery device B1 and the second battery device B2 to the power draining device 130.

In another embodiment, when both the charger device 120 and the power draining device 130 are both connected to the battery switching system, priority is given to charging the first battery device B1 and the second battery device B2 combination. However, in other different embodiments, priority can be given to providing power to the power draining device 130 from the first battery device B1 and the second battery device B2 combination.

In one embodiment, each battery device may be charged or discharged independently of each other. For instance, the battery switching system may charge or discharge (drain) the first battery device B1 completely before charging or discharging the second battery B2. In the scooter example mentioned above, power would be drained from one of the first battery device B1 and second battery device B2 before the other of the first battery device B1 and second battery device B2 is used. In this manner, the battery switching system is able to provide a more efficient power graph since the battery switching system can instantly and selectively switch between the different battery operation modes mentioned here and in previous embodiments depending on user usage behaviors and/or the environment.

Although the embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A battery switching system, comprising:
at least one first battery device and one second battery device having different voltages;
a battery switch device having an accommodating space to accommodate the first battery device and second battery device;
wherein when the battery switch device is in a charge mode, the battery switch device charges the first battery device and second battery device of lower voltage to match the voltage of the other of the first battery device and second battery device of higher voltage before simultaneously charging both the first battery device and second battery device; when the battery switch device is in a power mode, the battery switch device drains the first battery device and second battery device of high voltage to match the voltage of the other of the first battery device and second battery device of lower voltage before simultaneously draining both the first battery device and second battery device.

2. The battery switching system of claim 1, wherein the first battery device and the second battery device has different wattage.

3. The battery switching system of claim 1, wherein the battery switch device further includes a controller device.

4. The battery switching system of claim 3, wherein the battery switch device further includes at least one switch to correspond to each of the first battery device and the second battery device.

5. The battery switching system of claim 4, wherein the at least one switch is in parallel circuit with the first battery device and the second battery device, the controller device controls the at least one switch to charge or drain one of the first battery device and second battery device to match the voltage of the other of the first battery device and second battery device.

6. The battery switching system of claim 4, wherein the controller device is coupled to a charger device, the controller device receives power from the charger device and enters into the charge mode.

7. The battery switching system of claim 4, wherein the controller device is coupled to a power draining device, the controller device enters into the power mode and transfers power from the first battery device and the second battery device combination to the power draining device.

8. The battery switching system of claim 7, wherein the power draining device includes personal vehicles, personal electric vehicles, electric scooters, and electrically powered skateboards.

9. A battery operation method of a battery switching system, the battery switching system includes a first battery device, a second battery device, and a battery switch device connected to the first battery device and the second battery device, the method comprising:
a) determining if the battery switch device is connected to a charger device or a power draining device and generating a mode determination result;
b) according to the mode determination result, entering into a charge mode or a power mode;
c) charging one of the first battery device and the second battery device of lower voltage until both the first battery device and the second battery device have same voltage if in the charge mode, and then simultaneously charging both the first battery device and the second battery device;
d) draining one of the first battery device and the second battery device of higher voltage until both the first battery device and the second battery device have same voltage if in the power mode, and then simultaneously draining both the first battery device and the second battery device.

10. The method of claim 9, wherein the first battery device and the second battery device have different wattage, the step c) further comprises:
determining respective voltage levels of the first battery device and the second battery device.
